(19) United States
(12) Patent Application Publication
(10) Pub. No.: US 2026/0140560 A1
(43) Pub. Date: May 21, 2026

(54) RUNTIME ENERGY SAVING TOOL

(71) Applicant: HEWLETT PACKARD ENTERPRISE DEVELOPMENT LP, Spring, TX (US)

(72) Inventors: Sanyam Mehta, Eden Prairie, MN (US); Anna Yazhi Yue, Bloomington, MN (US); Torsten Wilde, Koenigs Wusterhausen (DE)

(21) Appl. No.: 19/223,439

(22) Filed: May 30, 2025

Related U.S. Application Data
(60) Provisional application No. 63/721,367, filed on Nov. 15, 2024.

(51) Int. Cl. G06F 1/324

(52) U.S. Cl. CPC G06F 1/324

(57) ABSTRACT

A region-aware GPU power/energy regulation method comprises periodically identifying a phase of execution of an application which is currently being executed by a GPU and measuring the utilization of the GPU (e.g., memory utilization) during execution of the identified phase. The utilization may be measured during a sampling period at both high and low GPU frequencies. A frequency sensitivity parameter is then determined for the identified phase based on the measured utilization of the GPU. A selected frequency for the identified phase is then determined based on the frequency sensitivity parameter. The GPU can then be instructed to set a frequency of the GPU to the selected frequency during execution of the remainder of the identified phase.

### CROSS REFERENCE TO RELATED APPLICATION

This application claims priority to U.S. Provisional Application No. 63/721,367, filed Nov. 15, 2024, which is incorporated by reference herein in its entirety.

### INTRODUCTION

Electricity consumption and efficiency is becoming an increasingly important concern for computing devices. As an example, high-performance computing (HPC) workloads, such as generative AI or other workloads, are becoming more popular and widespread, and these workloads often consume large amounts of electricity due to the computational power needed for the workload. However, the cost of such electricity, together with environmental concerns, makes it generally desired to reduce the amount of electricity that is consumed. Thus, it is generally desired to improve the electrical efficiency of computing systems so that they can consume less electricity for the same amount of work.

### BRIEF DESCRIPTION OF THE DRAWINGS

The present disclosure can be understood from the following detailed description, either alone or together with the accompanying drawings. The drawings are included to provide a further understanding of the present disclosure and are incorporated in and constitute a part of this specification. The drawings illustrate one or more examples of the present teachings and together with the description explain certain principles and operations. In the drawings:

FIG. 1 is a block diagram schematically illustrating an example information processing device configured to execute a region-aware GPU power/energy regulator.

FIG. 2 is a block diagram schematically illustrating an example information processing device configured to execute a region-aware CPU and GPU power/energy regulator.

FIG. 3 is a block diagram schematically illustrating an example HPC system comprising an HPC system control node configured to execute a region-aware power/energy regulator.

FIG. 4 is a process flow diagram illustrating an example method.

FIG. 5 is a block diagram schematically illustrating an example non-transitory computer readable medium comprising region-aware power/energy regulation instructions.

### DETAILED DESCRIPTION

Some of the largest consumers of electrical power/energy in a computing device are the processing units thereof, which generally includes one or more central processing units (CPUs) and which often also includes one or more graphics processing units (GPUs). Thus, one way to reduce the overall electricity consumption of a computing device or system of multiple computing device (e.g., HPC system) is to adjust the operating parameters of the CPU(s) and/or GPUs to consume less electricity. In particular, a parameter that can be adjusted to save electricity is the processor core clock frequency of the CPU or GPU. Specifically, some approaches to saving power reduce the processor frequency to a value lower than a normal operating value, which in many cases will reduce the amount of electricity consumed (to a lesser or greater extent, depending on circumstances, as will be described below).

Although reducing processor frequency can reduce electricity consumption, it can also degrade system performance. In other words, there is generally a tradeoff between saving electricity and system performance. In some cases, saving power at the cost of degraded performance may be considered acceptable, provided the performance degradation is minor relative to the electricity savings. However, if performance degradation is severe and/or if the energy savings are small, then the tradeoff may not be deemed acceptable. Thus, many power saving approaches that rely upon processor frequency reduction will attempt to determine a processor frequency that will strike a desired balance between system performance and electricity consumption.

In practice, it can be difficult to select the processor frequencies to produce the desired balance between system performance and electricity consumption. This is because it is generally not known in advance exactly how much performance degradation will occur or how much electricity savings will be realized in response to a given reduction in CPU and/or GPU frequency. Reducing the processor frequency of a CPU or a GPU by a given amount may produce different results under different circumstances, depending on what the CPU and/or GPU are doing at the time, i.e., depending on the current workload. For some workloads, reducing the CPU frequency a given amount may degrade performance only a little—for example, if the CPU is currently waiting on data to be transferred from memory, a reduction in a CPU core frequency will not significantly affect performance. For other workloads, reducing the CPU frequency by the exact same amount may degrade performance greatly—for example, if the CPU is currently executing a series of instructions that do not require any significant waiting for data, performance may be degraded proportionally to any reductions in frequency. The same may be true of GPUs, although there the bottlenecks may be different than with the CPUs, as explained in more detail below. Moreover, for some workloads a reduction in CPU frequency may reduce both power and energy usage, while in other cases the same reduction in CPU frequency may reduce power usage but have little to no effect on energy usage (or may even increase energy usage) (note that electricity consumption may include both an electrical power consumption component, referring to instantaneous power draw, i.e., voltage multiplied by current, and an electrical energy consumption, referring to the integration of the electrical power consumption across time, e.g., measured in Joules (J), Watt-hours (W·h), or similar units). Thus, there may not be any single CPU frequency or GPU frequency, or combination of the two, that achieves a desired balance between energy consumption and system performance for all circumstances.

There exist some approaches to balancing energy consumption and system performance for CPUs, as will be discussed in further detail below. However, these approaches are generally not applicable to GPUs.

To address these and other issues, disclosed herein is a region-aware power and energy regulation technique which is applicable to GPUs and which may be implemented in a region-aware power and energy regulator tool (“regulator tool”). The regulator tool may find a frequency for the GPU during a given phase of execution of an application that is expected to strike a desired balance between energy savings and system performance by calculating a frequency sensitivity parameter for that phase and setting the frequency accordingly, i.e., lowering the frequency for phases with low frequency sensitivity while keeping the frequency high for phases with high frequency sensitivity. The frequency sensitivity may be determined for a given phase based on observed GPU utilizations (e.g., memory utilizations) at both high and low frequencies, as measured during the given phase. In addition, the frequency may be determined based in part on a user-specified performance degradation parameter, which indicates how much performance degradation the user is willing to accept in order to increase efficiency.

The approach taken by the regulator tool may be contrasted with various other approaches at balancing energy consumption and system performance, as will be described in greater detail below.

One alternative approach to balancing energy consumption and system performance is application-aware power/energy regulation. This approach is based on the realization that the response of a system to a CPU frequency reduction or a GPU frequency reduction may vary from one application to another application. For example, certain primarily memory-bound applications, such as the application Ibm from the Standard Performance Evaluation Corporation (SPEC) 2017 benchmarking suite, may suffer very little performance degradation when the CPU or GPU frequency is reduced and may achieve significant power/energy savings—for example, in one test system, a reduction in CPU frequency by about 58% yielded a 37% power savings and a 36% energy savings, with only a 1.6% performance loss. On the other hand, a primarily compute-bound application, such as the application imagick from the SPEC 2017 benchmarking suite, may suffer much more performance degradation when the CPU or GPU frequency is reduced and may not achieve significant energy savings—for example, in one test system, a 52% reduction in CPU frequency results in 51% power savings, but at the cost of a 7.7% energy increase and a 53% performance drop. Consequently, an application-aware regulation approach may characterize applications based on their sensitivity to processor frequency (e.g., whether the application is compute bounded or memory bounded) and then control the processor frequency based on which type of application is being executed. In other words, the selected frequencies are determined on a per-application basis. For example, if the application being executed is characterized as compute-bound, then the processor frequency may be reduced less (or not at all) to avoid performance degradation, whereas if the application is characterized as memory-bound, the processor frequency may be reduced more to save power and energy with little performance degradation.

However, application-aware power/energy regulation may not always produce the best results. In particular, the response of a system to CPU or GPU frequency may vary not only from one application to another application, but also within different regions (e.g., functions, routines, loops, or other regions) of the same application. Many (perhaps most) applications contain some mixture of memory-bound regions and compute-bound regions—very rarely is an application uniformly memory bound or uniformly compute-bound. Even in applications that are, as a whole, primarily compute-bound or memory-bound, there is very often at least one region (sometimes multiple regions) of the application that does not follow the trend of the application as a whole. Accordingly, if a single CPU or GPU frequency is set for the entire application, this frequency is very likely to produce unsatisfactory energy consumption or system performance for at least some regions of the application.

For example, if under an application-aware regulation approach an application is characterized as memory-bound and thus a reduced frequency is set for the application, this may produce the desired power savings when the memory-bound regions are executed. But whenever one of the compute-bound regions of the application is executed, the performance of the system will suffer due to the lower frequency. Thus, the overall performance of the system (i.e., the time needed to complete the job) will be degraded somewhat. Accordingly, with an application-aware approach it is difficult to accurately achieve a desired balance between energy saving and performance, because performance will sometimes be worse than expected. Conversely, if under an application-aware regulation approach an application is characterized as compute-bound and thus a higher frequency is set, this may allow for the expected good performance during execution of the compute-bound regions. But whenever one of the memory-bound regions is executed, the higher frequency will result in unnecessary electricity consumption, i.e., an opportunity for saving energy without affecting performance is missed. Thus, the electrical efficiency of the system will be somewhat lower than it could have been. Accordingly, application-aware approaches may not achieve all of the electricity savings and/or system performance that is theoretically possible.

Another approach to selecting frequencies that balance energy consumption and performance is region-aware regulation, which has been proven effective for optimizing CPU frequencies. Examples of such techniques and systems that employ them can be found in U.S. patent application Ser. No. 18/388,573, titled “Region-Aware Power and Energy Regulation” and filed on 10 Nov. 2023, the contents of which are incorporated herein by reference in their entirety. However, approaches to selecting CPU frequencies, by themselves, may not be fully applicable to selecting GPU frequencies. CPUs and GPUs differ from one another in microarchitecture, and techniques for selecting a CPU frequency may produce poor results when applied without adaptation to a GPU.

The latest GPUs especially set themselves apart from the CPUs in terms of their memory bandwidth, thanks to the arrival and subsequent rapid advancements of the High-Bandwidth Memory (HBM) technology. However, the available thermal design power (TDP) for these GPUs has not increased at the same pace. This is because of both the end of Dennard scaling and also cooling limitations in servers. Since GPU compute capability scales with available power, GPU performance is bottlenecked by the power wall sooner than the memory (bandwidth) wall. For instance, memory bandwidth to TDP ratio has continually increased across GPU generations from both AMD and NVIDIA over the last few years, increasing from about 5 GB/s/W in 2020 to about 8 GB/s/W in 2024 for NVIDIA GPUs and from about 4 GB/s/W in 2020 to about 7 GB/s/W in 2023 for AMD GPUs.

With this increased bandwidth allocation for available compute/power, many GPU applications are less memory (bandwidth) bound. For instance, the average memory bandwidth consumed by various popular HPC/AI applications, such as the applications LAMMPS, PSDNS, MILC, QMCPACK, Workflow, and LLM-train (GPT), when run on both NVIDIA A100 and AMD MI250X GPUs does not exceed 50% of peak bandwidth even for AI/ML applications, and investigating further, only the applications MILC and LLM-train (GPT) spike to at most 70-80% peak bandwidth. The latest GPUs have even higher bandwidth as previously discussed, with the trend expected to continue with rapidly evolving high bandwidth memory (HBM) in the coming years. Consequently, the approach of finding memory bound phases and saving power by lowering clock does not generally yield the desired benefit with today's GPUs.

In order to select a frequency that achieves a desired balance between energy consumption and system performance, it is important to not only measure power but also performance at different clock rates. While measuring performance on CPUs is effectively supported through low-overhead performance counters easily exposed to the user through various APIs, on GPUs collecting analogous performance counters generally either causes prohibitive overhead or requires the use of intrusive application instrumentation that is often not viable.

In addition to overhead, another significant challenge with collecting performance counters on GPUs is the wide variability in which performance counters are available in different GPUs. In this regard, there is already significant disparity among CPU vendors such as Intel and AMD, and there is similar (or worse) disparity among GPU vendors (such as AMD and NVIDIA) in terms of performance events that could be collected. As a result, if a frequency selection approach relies on measuring a specific set of events/collecting specific performance counters on AMD GPUs, the approach is often not transferable to NVIDIA GPUs, and vice-versa.

Consequently, CPU frequency selection approaches, while effective for CPUs, may not be transferable to GPUs.

Some alternative approaches have been proposed pertaining to GPUs, but they can be undesirable under certain circumstances for various reason, including that they may rely on: (1) hardware changes (such as collecting fine-grained information about performance sensitivity to frequency in a low-overhead manner), or (2) some form of initial profiling of applications on the target system, or (3) offline training (e.g., a machine learning model) to predict power and performance based on observed performance events. In the first scenario, a solution depends on the corresponding GPU vendor to actually implement the proposed changes in hardware (which often does not materialize), and still may not be applicable for other vendors. In the second scenario, a solution requires an application to be run a priori on the system for it to be characterized for subsequent runs—this is often not possible or not acceptable on real systems running many applications from many users. Also, an application's behavior could also change across runs owing to change in input, available power, host hardware, etc. In the third scenario, a solution requires extensive offline training of a model on relevant applications using select performance counters to predict power and performance of test applications. Given the disparity in events across processors, this approach is not portable. Moreover, it still requires an a priori run of the application to collect the relevant events for the model to predict accurately for the subsequent runs. In a nutshell, many of these approaches face challenges in practical adoption on GPUs and GPU-based systems that often have many users and many applications.

The regulator tool disclosed herein addresses these difficulties by providing an effective yet practical tool for dynamic energy savings in GPU-based systems. The regulator tool finds two novel energy saving opportunities in addition to the traditional approach of targeting memory bound phases/applications. This results in much improved energy savings on GPUs. These additional opportunities include finding points of operation on the voltage-frequency (or power-frequency) curve of a GPU that can achieve a desired balance between energy savings and target performance, and adjusting GPU clocks based on observed memory utilization metrics of individual applications.

In addition, the regulator tool is versatile. As noted, in some cases the regulator tool uses GPU utilization (e.g., GPU memory bandwidth utilization and/or GPU engine utilization) as a metric in determining a frequency sensitivity of a phase of an application, and, unlike the performance counters used in alternative approaches described above, GPU utilization is an easily available and accurate metric across GPU vendors and generations that can be obtained with negligible overhead and no need to add custom hardware or instrumentation. In addition, GPU utilization—particularly GPU memory bandwidth utilization—is an effective metric in predicting an application phase's performance at different frequencies. The regulator tool thus works on GPUs from different vendors that each have widely varying support in terms of available performance events.

Furthermore, the regulator tool is a fully online/runtime solution that does not rely on a priori application profiling or model training. The regulator tool accurately predicts performance of application phases with low overhead at runtime and exploits the above-mentioned opportunities to adjust the frequency of the GPU for power/energy savings. This can be achieved through employing a low-overhead process on each system node that dynamically collects select performance events (e.g., GPU utilization) and attributes them to individual application phases. Because the effects of changing frequency (i.e., the frequency sensitivity) can be accurately predicted on a per-phase basis, the regulator tool can set the frequency in each phase to one that comes very close to achieving a desired balance between energy savings and system performance in each phase. In other words, the unexpected degradations in system performance and/or the missed opportunities for power/energy savings that can sometimes occur in application-aware approaches (when the character of an application phase does not match the overall character of the application as a whole) can be largely avoided.

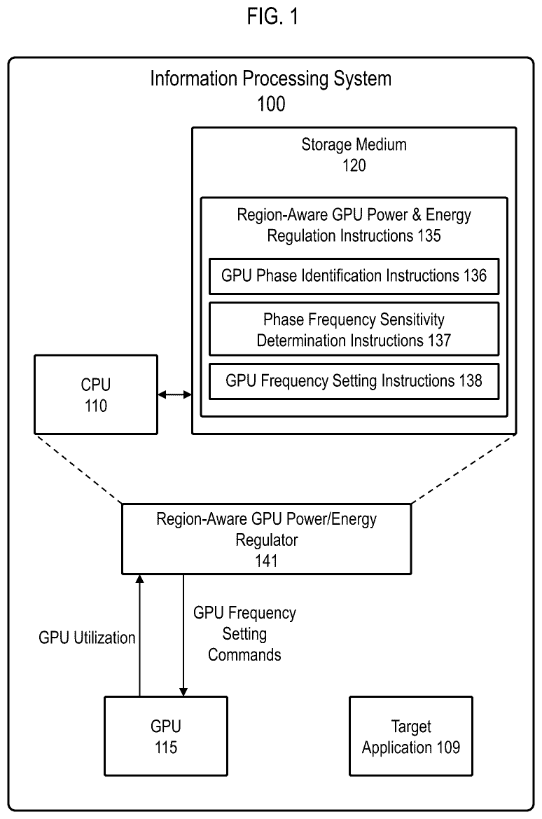

Turning now to FIGS. 1-5, example implementation of the regulator tool will be described in greater detail.

FIG. 1 is a block diagram schematically illustrating an information processing system 100. FIG. 1 is not intended to illustrate specific shapes, dimensions, positional relationships, or other structural details accurately or to scale, and implementations of the information processing system 100 may have different numbers and arrangements of the illustrated components and may also include other parts that are not illustrated.

As shown in FIG. 1, the information processing system 100 comprises a CPU 110 (also referred to as a processor), a storage medium 120 communicably connected to the CPU 110, and a GPU 115. The storage medium 120 comprises a non-transitory computer readable storage medium such as a hard-disk drive (HDD), solid-state drive (SSD), flash memory, random-access-memory (RAM), or any other non-transitory computer readable medium.

The storage medium 120 stores region-aware GPU power & energy regulation instructions 135, which are executable by the CPU 110. When the CPU 110 executes these instructions 135, a region-aware GPU power/energy regulator 141 is instantiated. The region-aware GPU power/energy regulator 141 performs operations described herein related to region-aware GPU power/energy regulation. This regulation comprises, among other things, characterizing individual phases of execution of a target application 109 (e.g., an HPC application) which is being run, at least in part, on a GPU, determining GPU frequencies for the individual phases that are expected to produce a desired balance between power/energy saving and performance, and setting the GPUs to use the determined frequencies during execution of the phases.

In some examples, the target application 109 for which regulation is being performed is being run on the same unit or node (e.g., server or compute node) which is also running the region-aware GPU power/energy regulator 141. In other words, in these examples, the CPU 110 and the GPU 115 are part of the same local unit or node. For example, the CPU 110 and GPU 115 may be housed within the same device chassis (e.g., tray) and may be coupled to the same system board (e.g., motherboard).

In these examples, the individual units or nodes may regulate their own power consumption/performance by monitoring their own execution of applications and adjusting their own parameters (e.g., GPU frequency) based therein. In some of these examples, in addition to the target application 109 being run, in part, on the GPU 115, the target application 109 may also be executed, in part, on a CPU of the local unit, which in some cases may be the same CPU 110 that is executing the regulator 141.

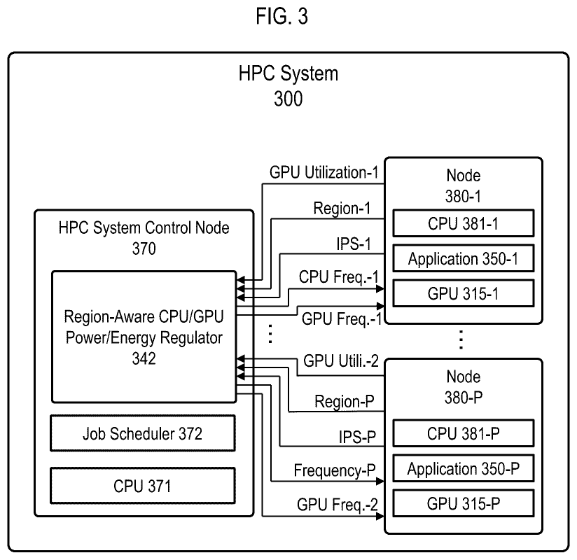

In other examples, the target application 109 may be run on one local unit (e.g., compute node) while the regulator 141 is run on a different local unit (e.g., on a different server or compute node, on a system controller node, etc.). In other words, in these examples, one unit or node is analyzing the other unit or node's execution of the target application 109 and may send instructions to that other node for how it should adjust its operating parameters. FIG. 3 illustrates one example of such a system, which will be described below.

The region-aware GPU power/energy regulator 141 is region-aware, meaning that it performs GPU frequency selection on a per-region basis, wherein “region” refers to a region of execution of the target application 109. However, the architectures and execution procedures of GPUs differ from those of CPUs, and therefore regions in region-aware GPU frequency selection processes may differ from regions in region-aware CPU frequency selection processes. In particular, in the GPU frequency selection performed by regulator 141, the regions comprise phases, wherein a “phase” comprises a period of execution having relatively uniform GPU utilization. Such phases may be identified on the fly (during execution of the application) based on observed GPU utilization. In contrast, in some CPU frequency selection approaches, regions may correspond to identifiable functions or processes.

The instructions 135 comprise GPU phase identification instructions 136. The GPU phase identification instructions 136, when executed, cause the regulator 141 to identify a phase of execution in a GPU executing the target application 109, which in this case is GPU 115. As noted, a phase is a period of execution having relatively uniform GPU utilization. When GPU utilization changes more than a threshold amount relative to a previous GPU utilization (e.g., based on a moving average), then this is considered by the regulator 141 to constitute a boundary between phases. Thus, the instructions 136 include instructions to monitor (e.g., periodically measure or determine) GPU utilization and to detect phase transitions corresponding to changes in GPU utilization exceeding a threshold amount. GPU utilization refers to GPU memory utilization, in some examples. In other examples, GPU utilization refers to GPU processor utilization. In other examples, GPU utilization refers to both GPU memory and GPU processor utilization (e.g., a phase change is detected if either of these utilization metrics experiences a significant change).

The instructions 135 further comprise phase frequency sensitivity determination instructions 137. These instructions 137 may be executed when it is determined that a new phase has begun, i.e., when a phase transition is detected. In some examples, when it is determined that a new phase has begun, the regulator 141 will engage a sampling procedure in which the GPU frequency is set to a predetermined value for the duration of a sampling period (in which the phase continues being executed) and a GPU utilization metric is measured during this period. The GPU utilization metric may be GPU memory utilization in some examples. In other examples, it may be GPU processor utilization. However, in some circumstances, GPU memory utilization proves to be a superior metric, giving greater accuracy with low overhead. The sampling procedure is performed for at least two different frequencies. For example, a first utilization measurement UTL_{high} may be sampled while the GPU frequency is at a predetermined high value Freq_{high}, and then a second utilization measurement UTL_{low} may be sampled while the GPU frequency is at a predetermined low value Freq_{low} (both being sampled during execution of the same given phase). UTL_{high_n} is an example of a “high-frequency utilization” mentioned elsewhere herein, and UTL_{low_n} is an example of a “low-frequency utilization” mentioned elsewhere herein. The frequency sensitivity parameter % FS for the given phase may then be determined based on UTL_{high} and UTL_{low}, for example by evaluating the following equation:

$$\% F {S}_{n} = 100 \% \cdot \frac{1 - \frac{U T {L}_{low\_n}}{U T {L}_{high\_n}}}{1 - \frac{{Freq}_{low\_n}}{{Freq}_{high\_n}}} . \qquad ( eq . 1 )$$

In equation 1, % FSₙ is the frequency sensitivity parameter for the n^{th} phase of the currently executing application (in this context, “n” is an arbitrary index used herein to identify a given phase), UTL_{high_n} is the high UTL measurement taken for the n^{th} phase, UTL_{low_n} is the low UTL measurement taken for the n^{th} phase, Freq_{high_n} is the high frequency at which UTL_{high_n} was sampled, and Freq_{low_n} is the low frequency at which UTL_{low_n} was sampled. % FSₙ is limited to values between 0 and 100%. In some examples, Freq_{high} is the maximum frequency and Freq_{low} is any lower frequency (for example, 70% of the maximum frequency). % FSₙ is an example of the “dependent variable” mentioned elsewhere herein, and UTL_{high_n}, UTL_{low_n}, Freq_{high_n}, and Freq_{low_n} are examples of the “independent variables” mentioned elsewhere herein.

The instructions 135 further comprise GPU frequency setting instructions 138. The frequency setting instructions 138 comprise instructions to determine a GPU frequency for the currently executing phase that satisfies a defined selection criterion based on its frequency sensitivity % FS and instructions to command the system 100 to set the GPU frequency to the determined frequency. The defined selection criterion may be a function that mathematically relates the frequency sensitivity parameter % FS to the determined frequency such that the higher the frequency sensitivity parameter % FS, the higher the determined frequency, and the lower the frequency parameter % FS, the lower the determined frequency. Thus, a frequency sensitive phase may be given a higher frequency to mitigate performance degradation, whereas a less frequency sensitive phase may be given a lower frequency to save electricity with little performance cost. Accordingly, the selected frequency for any given phase may be a frequency that can be expected to produce a desired balance between power/energy saving and system performance in that phase. Throughout execution of the application, the GPU's frequency may be changed repeatedly to different values, depending on the phase currently being executed so that, at any given time, the current GPU frequency is equal to the determined frequency for the current phase being executed (excluding during special periods in which the frequency may be set based on another criteria, such as during the sampling period).

In some examples, the determined frequency for a given phase is determined based not only on the frequency sensitivity parameter % FS for that phase, but also based on a performance degradation parameter (PD). The performance degradation parameter PD represents an acceptable level of performance degradation relative to the default performance that would be achievable at the default GPU frequency (without any adjustments to save electricity). For example, a PD of 5% would indicate that a 5% performance degradation is acceptable—i.e., a performance of 95% of the default level of performance. Thus, in some examples, the determined frequency for the given phase may be determined by evaluating an equation that relates both % FS and PD as input (i.e., independent) variables to the determined frequency as an output (i.e., dependent) variable. For example, in some implementations the determined frequency is given by the following equation:

$${Freq}_{n} = \frac{{Freq}_{{high}_{-}^{*} n}}{1 + \frac{P D}{\% F {S}_{n} ( 1 - P D )}} \qquad ( eq . 2 )$$

In equation 2, Freqₙ represents the selected frequency for the n^{th} phase, Freq_{high*_n} represents a predetermined high frequency, which may be equal in some examples to Freq_{high_n} used in equation 1 and/or to the default (normal) frequency that would have been used absent the frequency regulation process (in some examples, Freq_{high_n} is equal to this default frequency), PD is the performance degradation parameter, and % FSₙ is the frequency sensitivity parameter for the n^{th} phase. In some examples, the performance degradation parameter PD may be specified by a user, for example when they submit a job to be performed. In such examples, the regulator 141 may be configured to accept user input defining PD. In this manner, the region-aware frequency selection is easily customizable to strike a desired balance between electricity savings and performance. In some examples, a default value of PD may be stored in instructions 135 which may be used in the absence of user input defining PD.

Once the determined frequency Freqₙ is determined for the n^{th} phase, the frequency setting instructions 138 may thereafter instruct the GPU to use the determined frequency Freqₙ for the remainder of the phase. In some implementations, Dynamic Voltage Frequency Scaling (DVFS) is used to adjust the frequency of the GPU.

Note that the determined frequency, such as Freqₙ determined from equation 2, may be considered an “optimal” frequency in the sense that it is selected according to a defined selection approach that balances energy/power savings and system performance (e.g., equations 1 and 2). However, the determined frequency is not necessarily the best frequency possible in some absolute sense. Processes for selecting a frequency that balances energy/power savings and system performance may involve imperfect measurements, assumptions, and other uncertainties, and different approaches may use different (but equally valid) criteria for evaluating the optimality of the balance.

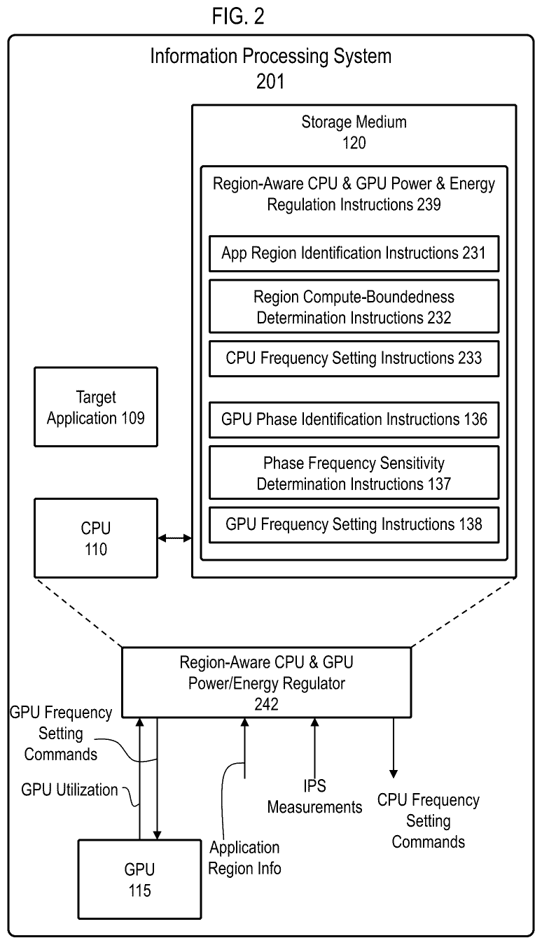

Turning now to FIG. 2, another system 201 is described. The system 201 may be identical to the system 100 except that the system 201 comprises Region-Aware CPU & GPU Power & Energy Regulation Instructions 239 which are executable to instantiate region-aware CPU & GPU power/energy regulator 242, instead of the region-aware GPU power & energy regulation instructions 135 that are executable to instantiate GPU power/energy regulator 141 in the system 100. The instructions 239 provide for optimization of both CPU and GPU. Thus, the instructions 239 are a superset of the instructions 135. That is, the instructions 239 include the instructions 136-138 described above for selecting processor frequencies for GPUs but also include additional instructions 231-233 for selecting processor frequencies for a CPU executing the target application 109, which may include the CPU 110. These instructions 231-233 may be the same as, or similar to, the instructions 131-133 described in U.S. patent application Ser. No. 18/388,573, which has been incorporated herein by reference. The instructions 231-233 may be executed when CPU optimization is desired, while instructions 136-138 may be executed when GPU optimization is desired. Thus, the region-aware CPU & GPU power/energy regulator 242 may be regarded as one implementation example of the region-aware GPU power/energy regulator 141, in which CPU frequency selection capabilities are combined with the GPU frequency selection capabilities. In some examples, instructions 231-233 may be executed when the target application 109 is run on a CPU, such as CPU 110 or another CPU, while instructions 136-138 may be executed when the target application 109 is run on GPU 115. In some examples, both sets of instructions 231-233 and 136-138 may be executed concurrently or sequentially when the target application 109 is run in part on GPU 115 and in part on a CPU, such as CPU 111 or another CPU.

The instructions 231-233 cause the regulator 242 to select CPU frequencies for execution regions of the target application 109 being executed on the CPU, wherein the frequencies are selected based on a compute-boundedness parameter (see equations 2 and/or 5 of U.S. patent application Ser. No. 18/388,573). This compute-boundedness parameter may be calculated for the regions based on instructions per section (IPS) measurements obtained during a sampling procedure performed during execution of the region (see equation 1 of U.S. patent application Ser. No. 18/388,573). The regions may be identified based on application region information provided to the regulator 242, as described in U.S. patent application Ser. No. 18/388,573.

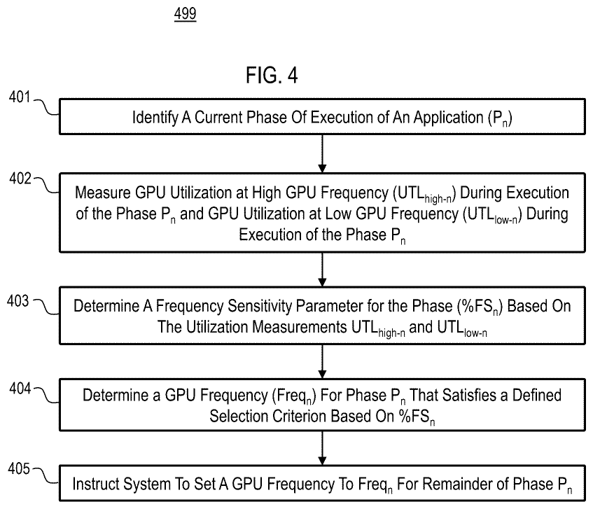

Turning now to FIG. 3, an example HPC system 300 will be described. The HPC system 300 is one example implementation of the information processing system 201 of FIG. 4. Some components of the HPC system 300 correspond to (e.g., are similar to or configurations of) components of the system 201, and these components are given similar reference numbers having the same last two digits, such as 242 and 342. The descriptions of the components of the system 201 are applicable to the similar components of the HPC system 300 unless indicated otherwise or logically contradictory, and duplicative descriptions are omitted. Although the HPC system 300 is one example of the system 201, the system 201 is not limited to the HPC system 300.

The HPC system 300 represents an example implementation of the system 201 in which the target application for which energy/power regulation is sought and the region-aware CPU/GPU power/energy regulator 342 are instantiated by different processors, specifically by different processors of different (distinct) nodes of an HPC system.

Specifically, the HPC system 300 comprises a plurality of compute nodes 380-1 to 380-P (where P is an integer equal to or greater than 2) that perform the computational tasks of jobs submitted to the HPC system 300, and an HPC system control node 370 that controls operations of the system as whole, including orchestrating the jobs. In some examples, the HPC system control node 370 is also a compute node that is tasked with system control regions, whereas in other examples the system control node 370 is a node dedicated solely to system control regions. Each compute node 380 comprises a CPU381 configured to execute an HPC application 350 (e.g., node 380-1 comprises CPU381-1 executing application 350-1, and so on). Each HPC application 350 comprises multiple regions, which may include multiple defined functions/processes (during CPU execution) and multiple phases (during GPU execution). At least one of the compute nodes 380 further includes a GPU 315 which may assist in the execution of the application 350. In the description below, to simplify the description it is assumed that each node 380 has a GPU 315 that is executing a portion of the application 350, but it should be understood that in some examples one or more nodes 380 may lack a GPU 315 or may have a GPU 315 that is not currently executing a portion of the application 350.

The HPC system control node comprises a CPU371 configured to instantiate the region-aware CPU/GPU power/energy regulator 342. The regulator 342 may be similar to the regulator 242 described above. In this example, the regulator 342 receives the region identification information, IPS measurements, and GPU utilization information from external sources, namely from nodes 380-1 to 380-P. For example, the operating system interfaces of these nodes may provide this information to the regulator 342. The node 380-1 may provide region identification information region-1 indicative of the region currently being executed by its CPU 381-1 and IPS measurements IPS-1 measured for that region based on its CPU381-1. In response to receiving this information, the regulator 342 may determine a CPU frequency for that region based on a defined selection criterion (e.g., equations 2 and/or 5 in U.S. patent application Ser. No. 18/388,573) and send frequency setting instructions CPU Frequency-1 to the node 380-1 that instruct the node 380-1 to set a frequency of its CPU 381-1 to the determined frequency. The node 380-1 may then adjust a frequency of its CPU 381-1 to the determined frequency as instructed, and the frequency may remain at the determined frequency until the node 370 sends a new CPU frequency setting instruction (e.g., in response to a new region being executed). In addition, the node 380-1 may provide GPU utilization information GPU Utl-1 for its GPU 315-1, and the regulator 342 may identify when a new phase of execution of the application 350 has begun on the GPU 315-1 based on the utilization information GPU Utl-1 using the techniques described above. The node 380-1 may then determine a GPU frequency for that phase based on a defined selection criterion (e.g., equation 2 above), and send frequency setting instructions GPU Frequency-1 to the node 380-1 that instruct the node 380-1 to set a frequency of its GPU 315-1 to the determined frequency. The node 380-1 may then adjust a frequency of its GPU 315-1 to the determined frequency as instructed, and the frequency may remain at the determined frequency until the node 370 sends a new GPU frequency setting instruction (e.g., in response to a new phase being detected). Similar p-processes are performed for the other nodes 380. In this manner, each node 380 may have its CPU and/or GPU frequency set individually to values that will produce a desired balance of energy/power savings and system performance based on the regions (phases) currently being executed on their respective CPUs 381 and GPUs 315. In some examples, the same region may be executed on multiple nodes 380 (concurrently, or at different timings), and in some examples when this happens the frequency which was determined for one node 380 may be applied to another node without having to characterize the region again for the other node 380—in other words, in some examples, the regulator 342 may reuse information learned with respect to one node 380 in the regulation of another node 380. In some examples, a single instance of regulator 342 may be responsible for regulating each node 380 (receiving the input data from the node 380, characterizing regions of the node 380, and sending frequency setting commands to the node 380). In other examples, multiple instances of the regulator 342 may be instantiated, with each instance of the regulator 342 regulating a corresponding one of the nodes 380.

In some examples, the HPC system control node 370 also comprises a job scheduler 372. The job scheduler 372 receives job requests from users, which may include an indication of an application that is desired to be run and a data set to use for the application. The job scheduler 372 may then schedule the job on the nodes 380. The job scheduler 372 may, in some examples, be configured to allow a user to specify the performance degradation parameter PD when entering a job, and may communicate this information to the regulator 342 to enable the regulator 342 to use this information in calculating the optimal frequencies for regions of the application.

Although the HPC system 300 is described as an implementation of system 201, a similar HPC system 300 which is an implementation of the system 100 may also be used. In such a system, an implementation of the region aware GPU power/energy regulator 141 may be used in the HPC system control node 370 instead of the regulator 342. In such a system, compute nodes may send GPU utilization information to the control node and the control node may determine GPU frequences for the compute nodes based therein, as described above in relation to FIG. 3, but the compute nodes need not necessarily send the region or IPS information to the control node and the control node need not necessarily determine CPU frequencies for the compute nodes.

FIG. 4 illustrates a method 499. The method 499 may be performed by a region aware power/energy regulator, such as any of the regulators 141, 242, and 342 described above. This method determines a frequency for a GPU executing a target application, and in particular may determine the frequency on a per-phase basis based on a defined selection criterion that may strike a desired balance between power/energy savings and system performance. The method 499 may be an example of a process which the instructions 135 cause to be performed when they are executed.

In step 401, the regulator identifies a current phase of execution of an application on a GPU, denoted Pₙ in FIG. 6, where “n” is an index identifying the current phase. The identification of the current phase may include identifying a transition from a previous phase to the current phase. This may comprise monitoring GPU utilization and determining that a transition has occurred if the GPU utilization changes by more than a threshold amount. GPU utilization refers to GPU memory utilization, in some examples. In other examples, GPU utilization refers to GPU processor utilization. In other examples, GPU utilization refers to both GPU memory and GPU processor utilization (e.g., a phase change is detected if either of these utilization metrics experiences a significant change).

In step 402, the regulator measures the utilization of the GPU, during execution of the phase Pₙ, at both high and low frequencies, producing measurements UTL_{high-n} and UTL_{low-n}. The utilization may be memory utilization, GPU processor utilization, or both. To measure these utilizations, the regulator may change the frequency of the GPU between two predetermined values, one high the other low, for predetermined measurement periods, and observe the GPU utilization while the GPU operates at those high and low frequencies.

In step 403, the regulator determines a frequency sensitivity parameter % FSₙ for the current phase based on the measured utilizations UTL_{high-n} and UTL_{low-n}. This frequency sensitivity parameter % FSₙ represents how sensitive the phase is to changes in frequency. In some examples, equation 1 above is used to determine % FSₙ.

In step 404, the regulator determines a GPU frequency (Freqₙ) for the phase Pₙ that satisfies a defined selection criterion based on the frequency sensitivity parameter % FSₙ. For example, equation 2 above may be used to determine Freqₙ. This frequency may be a frequency that strikes a desired balance between power/energy savings and system performance, as defined by the selection criterion.

In step 405, the regulator instructs the system to set the GPU frequency to Freqₙ. Generally, the GPU frequency will remain at Freqₙ at least for the remainder of the current phase Pₙ, assuming some other process does not intervene to change the frequency. An example of another process that might intervene to change the frequency may be a thermal regulation process which may throttle the GPU if excessive temperatures are sensed.

After setting the GPU frequency in step 405, the method 499 may be repeated, with the GPU utilization being monitored until the current phase ends and the beginning of a new phase is detected (step 401), whereupon the GPU frequency may be changed again to suite the new phase (steps 402-405).

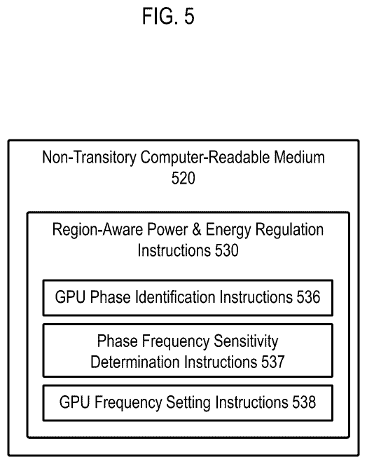

Turning now to FIG. 5, a non-transitory computer-readable medium 520 is described. The non-transitory computer-readable medium 520 comprises region-aware power & energy regulation instructions 530. The instructions 530 are similar to the instructions 130 described above and may include instructions to perform the method 499 described above. In particular, the instructions 530 include GPU phase identification instructions 536 which may be similar to the instructions 136, phase frequency sensitivity determination instructions 537 which may be similar to the instructions 137, and GPU frequency setting instructions 533 which may be similar to instructions 138.

In the description above, various types of electronic circuitry are described. As used herein, “electronic” is intended to be understood broadly to include all types of circuitry utilizing electricity, including digital and analog circuitry, direct current (DC) and alternating current (AC) circuitry, and circuitry for converting electricity into another form of energy and circuitry for using electricity to perform other regions. In other words, as used herein there is no distinction between “electronic” circuitry and “electrical” circuitry.

It is to be understood that both the general description and the detailed description provide examples that are explanatory in nature and are intended to provide an understanding of the present disclosure without limiting the scope of the present disclosure. Various mechanical, compositional, structural, electronic, and operational changes may be made without departing from the scope of this description and the claims. In some instances, well-known circuits, structures, and techniques have not been shown or described in detail in order not to obscure the examples. Like numbers in two or more figures represent the same or similar elements.

In addition, the singular forms “a”, “an”, and “the” are intended to include the plural forms as well, unless the context indicates otherwise. Moreover, the terms “comprises”, “comprising”, “includes”, and the like specify the presence of stated features, steps, operations, elements, and/or components but do not preclude the presence or addition of one or more other features, steps, operations, elements, components, and/or groups. Components described as connected may be electronically or mechanically directly connected, or they may be indirectly connected via one or more intermediate components, unless specifically noted otherwise. Mathematical and geometric terms are not necessarily intended to be used in accordance with their strict definitions unless the context of the description indicates otherwise, because a person having ordinary skill in the art would understand that, for example, a substantially similar element that regions in a substantially similar way could easily fall within the scope of a descriptive term even though the term also has a strict definition.

And/or: Occasionally the phrase “and/or” is used herein in conjunction with a list of items. This phrase means that any combination of items in the list—from a single item to all of the items and any permutation in between—may be included. Thus, for example, “A, B, and/or C” means “one of {A}, {B}, {C}, {A, B}, {A, C}, {C, B}, and {A, C, B}”.

Elements and their associated aspects that are described in detail with reference to one example may, whenever practical, be included in other examples in which they are not specifically shown or described. For example, if an element is described in detail with reference to one example and is not described with reference to a second example, the element may nevertheless be claimed as included in the second example.

Unless otherwise noted herein or implied by the context, when terms of approximation such as “substantially,” “approximately,” “about,” “around,” “roughly,” and the like, are used, this should be understood as meaning that mathematical exactitude is not required and that instead a range of variation is being referred to that includes but is not strictly limited to the stated value, property, or relationship. In particular, in addition to any ranges explicitly stated herein (if any), the range of variation implied by the usage of such a term of approximation includes at least any inconsequential variations and also those variations that are typical in the relevant art for the type of item in question due to manufacturing or other tolerances. In any case, the range of variation may include at least values that are within +1% of the stated value, property, or relationship unless indicated otherwise.

Further modifications and alternative examples will be apparent to those of ordinary skill in the art in view of the disclosure herein. For example, the devices and methods may include additional components or steps that were omitted from the diagrams and description for clarity of operation. Accordingly, this description is to be construed as illustrative only and is for the purpose of teaching those skilled in the art the general manner of carrying out the present teachings. It is to be understood that the various examples shown and described herein are to be taken as exemplary. Elements and materials, and arrangements of those elements and materials, may be substituted for those illustrated and described herein, parts and processes may be reversed, and certain features of the present teachings may be utilized independently, all as would be apparent to one skilled in the art after having the benefit of the description herein. Changes may be made in the elements described herein without departing from the scope of the present teachings and following claims.

It is to be understood that the particular examples set forth herein are non-limiting, and modifications to structure, dimensions, materials, and methodologies may be made without departing from the scope of the present teachings.

Other examples in accordance with the present disclosure will be apparent to those skilled in the art from consideration of the specification and practice of the invention disclosed herein. It is intended that the specification and examples be considered as exemplary only, with the following claims being entitled to their fullest breadth, including equivalents, under the applicable law.

What is claimed is:

1. An information processing system, comprising:
a processor;
a non-transitory storage medium comprising instructions executable by the processor to instantiate a region-aware power/energy regulator configured to,
periodically identify a phase of execution of an application which is currently being executed by a graphics processing unit (GPU);
measure utilization of the GPU during execution of the identified phase;
determine a frequency sensitivity parameter of the identified phase based on the measured utilization;
determine a selected GPU frequency for the identified phase based on the frequency sensitivity parameter thereof; and
instruct the GPU to set a frequency of the GPU to the selected GPU frequency during execution of the identified phase.

2. The information processing system of claim 1,
wherein measuring the utilization of the GPU comprises setting the frequency of the GPU to a high frequency and measuring the utilization of the GPU to determine a high-frequency utilization, and setting the frequency of the GPU to a low frequency and measuring the utilization of the GPU to determine a low-frequency utilization, and
wherein the frequency sensitivity parameter is determined based on the high-frequency utilization and the low-frequency utilization.

3. The information processing system of claim 2,
wherein determining the frequency sensitivity parameter of the identified phase comprises evaluating an equation which relates the high frequency, the low frequency, the high-frequency utilization and the low-frequency utilization as input variables to the frequency sensitivity parameter as an output variable.

4. The information processing system of claim 3,
wherein determining the selected GPU frequency for the identified phase comprises evaluating an equation which relates the frequency sensitivity parameter and a performance degradation parameter as independent variables to the selected GPU frequency as a dependent variable, and
wherein the performance degradation parameter is indicative of an acceptable level of performance degradation relative to a default performance.

5. The information processing system of claim 4,
wherein the region-aware power/energy regulator is configured to receive user input specifying the performance degradation parameter.

6. The information processing system of claim 1,
wherein the utilization of the GPU comprises memory utilization of the GPU.

7. The information processing system of claim 1,
wherein the utilization of the GPU comprises processor utilization of the GPU.

8. The information processing system of claim 1,
wherein the utilization of the GPU comprises a combination of memory utilization and processor utilization of the GPU.

9. The information processing system of claim 1,
wherein the processor and the GPU are part of the same node.

10. The information processing system of claim 9,
wherein the information processing system comprises a compute node of a high-performance computing (HPC) system.

11. The information processing system of claim 1,
wherein the processor and the GPU are part of distinct nodes.

12. The information processing system of claim 11,
wherein the information processing system comprises a high-performance compute (HPC) system, the processor is part of a system controller node of the HPC system, and the GPU is part of a compute node of the HPC system.

13. The information processing system of claim 1,
wherein identifying the phase of execution comprises monitoring utilization of the GPU and determining a new phase has begun in response to detecting the utilization has changed more than a threshold amount relative to a previous value of the utilization.

14. A region-aware power/energy regulation method, comprising:
periodically identifying a phase of execution of an application which is currently being executed by a GPU;
measuring a utilization of the GPU during execution of the identified phase;
determining a frequency sensitivity parameter of the identified phase based on the measured utilization;
determining a selected frequency for the identified phase based on the frequency sensitivity parameter thereof; and
instructing the GPU to set a frequency of the GPU to the selected frequency during execution of the identified phase.

15. The method of claim 14,
wherein measuring the utilization of the GPU comprises setting the frequency of the GPU to a high frequency and measuring the utilization of the GPU to determine a high-frequency utilization and setting the frequency of the GPU to a low frequency and measuring the utilization of the GPU to determine a low-frequency utilization, and
wherein the frequency sensitivity parameter is determined based on the high-frequency utilization and the low-frequency utilization.

16. The method of claim 15, further comprising:
wherein determining the frequency sensitivity parameter of the identified phase comprises evaluating an equation which relates the high frequency, the low frequency, the high-frequency utilization and the low-frequency utilization as input variables to the frequency sensitivity parameter as an output variable.

17. The method of claim 14,
wherein determining the selected GPU frequency for the identified phase comprises evaluating an equation which relates the frequency sensitivity parameter and a performance degradation parameter as independent variables to the selected GPU frequency as a dependent variable, and
wherein the performance degradation parameter is indicative of an acceptable level of performance degradation relative to a default performance.

18. The method of claim 14,
wherein the utilization of the GPU comprises memory utilization of the GPU.

19. The method of claim 14,
wherein identifying the phase of execution comprises monitoring utilization of the GPU and determining a new phase has begun in response to detecting the utilization has changed more than a threshold amount relative to a previous value of the utilization.

20. A non-transitory storage medium comprising instructions executable by a processor to instantiate a region-aware power/energy regulator configured to,
periodically identify a phase of execution of an application which is currently being executed by a GPU;
measure utilization of the GPU during execution of the identified phase;
determine a frequency sensitivity parameter of the identified phase based on the measured utilization;
determine a selected frequency for the identified phase based on the frequency sensitivity parameter thereof; and
instruct the GPU to set a frequency of the GPU to the selected frequency during execution of the identified phase.
